(19) United States
(12) Patent Application Publication
(10) Pub. No.: US 2019/0325244 A1
(43) Pub. Date: Oct. 24, 2019

(54) SYSTEM AND METHOD TO ENABLE CREATIVE PLAYING ON A COMPUTING DEVICE

(71) Applicant: SKIPY INTERACTIVE PVT LTD, Bangalore (IN)

(72) Inventor: AJAY KESAVA DAS, BANGALORE (IN)

(21) Appl. No.: 16/024,966

(22) Filed: Jul. 2, 2018

(30) Foreign Application Priority Data
Apr. 20, 2018 (IN) 201841015068

(51) Int. Cl. G06K 9/32; G06F 3/0354; G06T 13/80; G06T 11/00; G06T 9/00; G06F 3/01

(52) U.S. Cl. CPC G06K 9/3233; G06F 3/03545; G06F 3/017; G06T 11/001; G06T 9/008; G06T 13/80

(57) ABSTRACT

A system and a method to enable creative playing on a computing device is disclosed. The system includes a surface configured to provide a medium for a first user input. The system also includes a controller configured to monitor and control the navigation based on a second user input. The system further includes an imaging device adapter operatively coupled to the computing device and houses an optical element. The optical element is configured to transfer the first user input in the computing device as a visual object. The computing device includes an image processing subsystem configured to identify a region of interest in the visual object. The image processing subsystem is also configured to convert the region of interest into a plurality of vector objects. The image processing subsystem is configured to map a predefined animation on the plurality of vector objects to enable creative playing.

### CROSS-REFERENCE TO RELATED APPLICATION

This application claims the benefit of Complete Patent Application bearing application no. 201841015068, filed on Apr. 20, 2018 in India.

### BACKGROUND

Embodiments of a present disclosure relate to virtual painting system and more particularly to, system and method to enable creative playing on a computing device.

Popular game and computer systems have painting-based games in which regular palm-type controllers or a computer mouse has been used to move a displayed virtual paintbrush on a virtual canvas. In today's realm of multiple screens kids are subjected to play through gadgets. Creative play on gadgets is always achieved by clicking and dragging fingers endlessly over screen. Most painting and drawing applications available on mobile devices direct the use of fingers to draw, pick colours and paint. Instead, certain system promotes the use of stylus. Either of such methods invariantly provide a mechanism to draw on the screen. However, such systems do not immerse a user into a realistic gaming experience of painting or drawing on real or virtual surfaces.

In some systems, one approach of capturing handwritten information by using a pen is used. In such approach the location of the pen is determined during painting. The pen functions by using a camera to capture an image of a surface encoded with a predefined pattern to determine a location of a pen on the surface. Some systems also have electronics arrangement to determine the position of the pen in the two-dimensional and three-dimensional space. However, such systems have low efficiency for the determination of the location of the pen on the surface.

Hence, there is a need for an interactive system for creative playing to address the aforementioned issues.

### BRIEF DESCRIPTION

In accordance with an embodiment of the present disclosure, a system to enable creative playing on a computing device is provided. The system includes a surface configured to provide a medium for a first user input. The system also includes a controller configured to monitor and control the navigation based on a second user input. The system further includes an imaging device adapter operatively coupled to the computing device and houses an optical element. The optical element is configured to transfer the first user input to the computing device as an visual object using an imaging device. The computing device includes an image processing subsystem configured to identify a region of interest in the visual object . The image processing subsystem is also configured to convert the region of interest into a plurality of vector objects. The image processing subsystem is further configured to map a predefined animation on the plurality of vector objects to enable creative playing.

In accordance with another embodiment of the present disclosure, a method to enable creative playing on a computing device is provided. The method includes providing a medium for a first user input. The method also includes monitoring and controlling the navigation based on a second user input. The method further includes transferring the user input to the computing device as a visual object. The method further includes identifying a region of interest in the visual object . The method further includes converting the region of interest into a plurality of vector objects. The method further includes mapping a predefined animation on the plurality of vector objects to enable creative playing.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system to enable creative playing on a computing device in accordance with an embodiment of the present disclosure;

FIG. 2 is a block diagram of an exemplary system to enable creative playing on a computing device of FIG. 1 in accordance with an embodiment of the present disclosure;

FIG. 3 illustrates a flow chart representing the steps involved in a method to enable creative playing on a computing device of FIG. 1 in accordance with an embodiment of the present disclosure; and

FIG. 4 is an exemplary flow chart representing the steps involved in a method (250) for operating the visual object processing module to enable creative playing in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and method to enable creative playing on a computing device. The system includes a surface configured to provide a medium for a first user input. The system also includes a controller configured to monitor and control the navigation based on a second user input. The system further includes an imaging device adapter operatively coupled to the computing device and houses an optical element. The optical element is configured to transfer the first user input to the computing device as a visual object using an imaging device. The computing device includes an image processing subsystem configured to identify a region of interest in the visual object. The image processing subsystem is also configured to convert the region of interest into a plurality of vector objects. The image processing subsystem is further configured to map a predefined animation on the plurality of vector objects to enable creative playing.

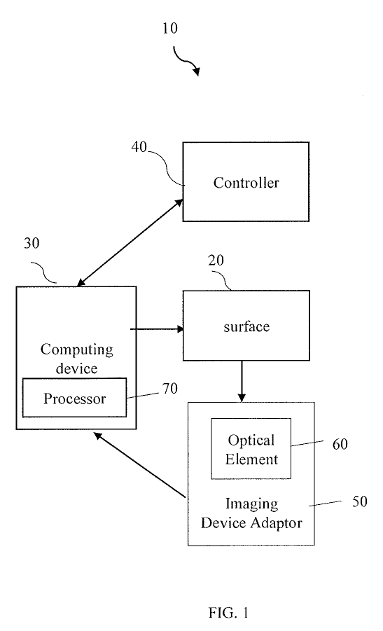

FIG. 1 is a block diagram of a system (10) to enable creative playing on a computing device (30) in accordance with an embodiment of the present disclosure. The system (10) includes a surface (20) configured to provide a medium for a first user input. In one embodiment, the user input may include a sketching input, a painting input or a writing input. In some embodiments, the surface (20) may include a magnetic clip (not shown in FIG. 1) to hold a paper in place on the surface (20). In such embodiment, the paper (not shown in FIG. 1) clipped on the surface (20) may provide a medium for the user input. In a specific embodiment, the system (10) may include a stand (not shown in FIG. 1) configured to hold the computing device (30) at an angle to the surface (20). In one embodiment, the computing device (30) may include a tablet or a mobile phone. In such embodiment, the stand may be integrated into the surface (20) to be a single unit.

[19] The system (10) further includes a controller (40) configured to monitor and control the navigation based on a second user input. In a specific embodiment, the controller (40) may include a plurality of control buttons configured to receive the second user input. The second user input may be a control signal input by the user using the plurality of control buttons. In some embodiments, controller (40) is coupled to the computing device (30) using plug and jack arrangement. The controller (40) plugs in to the jack of the computing device (30). The controller (40) draws power from the computing device (30) as controller (40) does not have a power source.

Furthermore, the system (10) includes an imaging device adapter (50) operatively coupled to the computing device (30) and houses an optical element (60). The optical element (60) is configured to transfer the first user input to the computing device (30) as a visual object using an imaging device (not shown in FIG. 1). In a specific embodiment, the visual object may include an image or a video. In one embodiment, the optical element (60) may include a periscopic prism. The optical element (60) works on a property of inversion of field of view. In some embodiments, the computing device (30) may include the imaging device which captures the first user input on the surface (20) with the help of optical element (60).

Moreover, the computing device (30) includes an image processing subsystem (70) which is configured to identify a region of interest in the visual object . In a specific embodiment, the computing device (30) may be a standalone screen. The image processing subsystem (70) is further configured to convert the region of interest into a plurality of vector objects. In one embodiment, the plurality of vector objects may be represented in a two-dimensional space. In another embodiment, the plurality of vector objects may be represented in a three-dimensional model in the two-dimensional space. In such embodiment, the system (10) may generate 3D models from the drawing with one or more models for mesh generation and modelling.

The image processing subsystem (70) is further configured to map a predefined animation on the plurality of vector objects to enable creative playing. In some embodiments, the image processing subsystem (70) may map the predefined animation on the plurality of vector objects to create a storyline from the user input. In one embodiment, the image processing subsystem (70) of the computing device (30) may be located on a cloud server and utilize a cloud server memory for offline content generation such as story book or video.

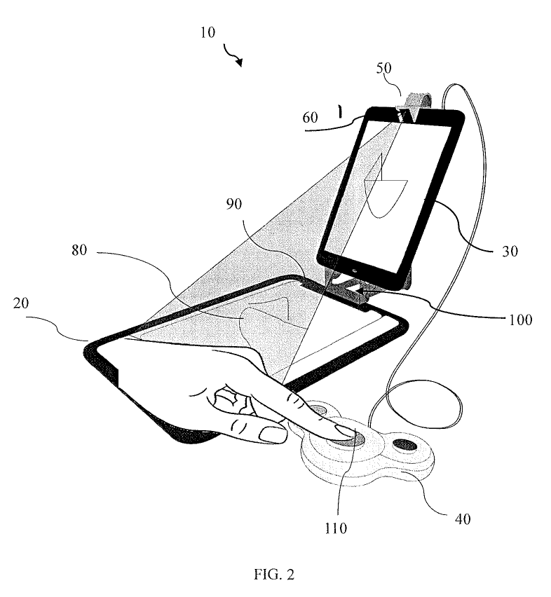

FIG. 2 is a block diagram of an exemplary system (10) to enable creative playing on a computing device (30) of FIG. I in accordance with an embodiment of the present disclosure. The system (10) relates to a gaming kit build around the concept of mixed reality. The gaming kit when plugged in to the computing device (30), instantly turns the computing device (30) into a console for creative playing. Such gaming kit may engage a user in creative playing with a pen and a paper (80) and the user may see his or creations come to life and action on the console. To enable the creative playing, the system (10) includes a surface (20) configured to provide a medium for a first user input such as drawing. In one embodiment, the user input may include a sketching input, a painting input or a writing input. In such embodiment, the user may draw a sketch or a painting on the surface (20) using a pen. In a specific embodiment, the surface may include a drawing pad.

In some embodiments, the surface (20) may include a magnetic clip (90) to hold the paper (80) in place on the surface (20). In such embodiment, the paper (80) clipped on the surface (20) may provide a medium for the user input such as drawing. The user may draw a sketch or a painting on the paper (80) clipped on the surface (20) using the pen. The system (10) includes a stand (100) configured to mount the computing device (30) at an angle to the surface (20). In one embodiment, the computing device (30) may include a tablet or a mobile phone. In such embodiment, the stand (100) may be integrated into the surface (20) to be a single unit.

The system (10) further includes a controller (40) configured to monitor and control the navigation based on the input provided by the user using the controller. In a specific embodiment, the controller (40) may include a plurality of control buttons (110) configured to receive the second user input. The controller (40) plugs in to the jack of the computing device (30). In such embodiment, the controller (40) may include three control buttons and a plug that may plugs into the 3.5mm audio jack input of the computing device (30). In some embodiments, the controller may plug into a USB port of the computing device. In one embodiment, the controller (40) may draw the power from the computing device (30) as controller (40) does not have a power source. In another embodiment, the controller may draw the power from an in-built power source of controller. The controller (40) triggers the capture of the visual object which the controller (40) triggers the capture of each step of drawing. The controller (40) aids in the creative play process by advancing or repeating certain steps in the creative game play as directed by the button presses in the controller (40).

Furthermore, the system (10) includes an imaging device adapter (50) operatively coupled to the computing device (30) and houses an optical element (60). The optical element (60) is configured to transfer the drawing to the computing device (30) as a visual object using an imaging device. In a specific embodiment, the visual object may include an image or a video. In one embodiment, the optical element (60) may include a periscopic prism. In a specific embodiment, the imaging device may include a camera. The optical element (60) works on a property of inversion of field of view. The optical element inverts the field of view in front of the camera and the camera captures the visual object of the drawing or writing. The system (I 0) may include a plurality of image processing techniques done on the visual object obtained through the imaging device.

Moreover, the computing device (30) includes an image processing subsystem (not shown in FIG. 2) which is configured to generate a plurality of vectors from the visual object to approximately build a plurality of vectors from the drawing in the two-dimensional space. The image processing subsystem (not shown in FIG. 2) may expand such information to represent the drawing as a three-dimensional model in the same two-dimensional space. The image processing subsystem (not shown in FIG. 2) runs a plurality of image processing techniques to identify the region of interest in the drawing or the input received. Using the plurality of imaging technique, the region of interest identified is converted into a plurality of vectors.

The image processing subsystem (not shown in FIG. 2) is further configured to identify the plurality of vectors generated as objects. By using an imaging model, a predefined animation from the visual object frame is mapped to the plurality of vector objects and the objects animate accordingly. In some embodiments, the image processing subsystem may map the predefined animation on the plurality of vector objects to create a storyline from the drawing. In one embodiment, the image processing subsystem of the computing device (30) may be located on a cloud server. The drawing is sent to a cloud server for offline content generation such as story book or video from the drawing.

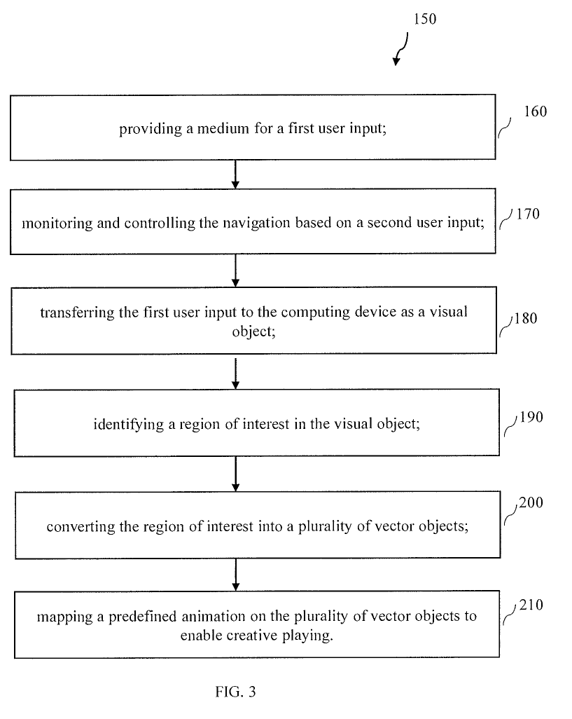

FIG. 3 illustrates a flow chart representing the steps involved in a method (150) to enable creative playing on a computing device of FIG. 1 in accordance with an embodiment of the present disclosure. The method (150) includes providing a medium for a user input in step 160. In one embodiment, providing a medium for a user input may include providing a medium for a sketching input, a painting input or a writing input. The method (150) also includes monitoring and controlling the user input and navigation based on the user input in step 170.

Furthermore, the method (150) includes transferring the user input to the computing device in step 180. The method (150) further includes identifying a region of interest in the user input in step 190. The method (150) further includes converting the region of interest into a plurality of vector objects in step 200. The method (150) further incudes mapping a predefined animation on the plurality of vector objects to enable creative playing in step 210. In some embodiments, mapping a predefined animation on the plurality of vector objects may include mapping a predefined animation on the plurality of vector objects to create a storyline from the user input.

In a specific embodiment, the method (150) includes utilize a cloud server memory for offline content generation such as story book or video.

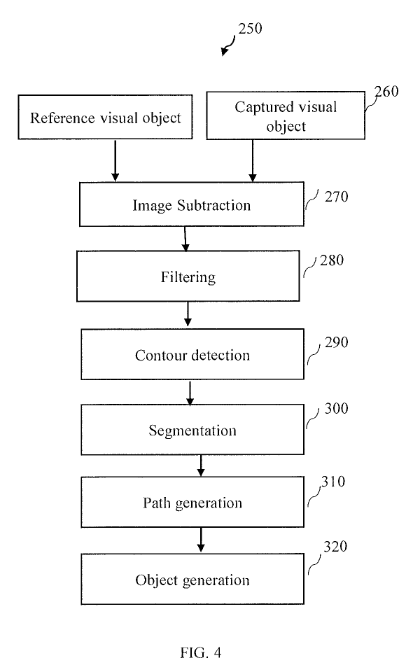

FIG. 4 is an exemplary flow chart representing the steps involved in a method (250) for operating the image processing module to enable creative playing in accordance with an embodiment of the present disclosure. The method (250) includes receiving the visual object captured by the imaging device and a receiving a reference visual object in step 260. The method (250) also includes subtracting a captured visual object and the reference visual object to obtain an intermediate visual object in step 270. The method (250) further includes filtering the intermediate visual object in step 280. The method (250) further includes performing a contour detection on a filtered intermediate visual object in step 290. The method (250) further includes segmenting a contoured visual object in various segments in step 300. The method (250) further includes generating a plurality of paths based on a segmented visual object in step 310. The method (250) further includes identifying one or more objects based on a plurality of generated path in step 320.

Various embodiments of the present disclosure enable creative playing on a computing device like a mobile device or a tablet by providing a mechanism to draw with a physical pen and paper. Engage a user in creative playing with a pen and a paper and the user may see his or creations come to life and action on the console and thereby bring in the same fun and excitement of creative playing on any physical medium.

Furthermore, the system pushes the limit of creative playing by building various system components that enables to draw anything in front of the computing device and bring those creations to life and action within the computing device.

In addition, the system engages the child with unique storytelling techniques to simulate creative thinking in kids to play via creative playing as the system utilizes a cloud server memory for offline content generation such as story book or video.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system (10) to enable creative playing on a computing device (30) comprising:
a surface (20) configured to provide a medium for a first user input;
a controller (40) configured to monitor and control the navigation based on a second user input;
an imaging device adapter (50) operatively coupled to the computing device (30) and houses an optical element (60); wherein the optical element (60) is configured to transfer the first user input to the computing device as a visual object (30) using an imaging device;
wherein the computing device (30) comprises an image processing subsystem (70) configured to:
identify a region of interest in the visual object;
convert the region of interest into a plurality of vector objects; and
map a predefined animation on the plurality of vector objects to enable creative playing.

2. The system (10) as claimed in claim 1, wherein the first user input comprises a sketching input, a painting input or a writing input.

3. The system (10) as claimed in claim 1, wherein the surface (20) comprises a magnetic clip to hold a paper in place on the surface (20).

4. The system (10) as claimed in claim 1, wherein the controller (40) comprises a plurality of control buttons configured to receive the second user input.

5. The system (10) as claimed in claim 1, wherein the controller (40) is coupled to the computing device (30) using plug and jack arrangement.

6. The system (10) as claimed in claim 1, wherein the optical element (60) comprises a periscopic prism, wherein the imaging device comprises a camera.

7. The system (10) as claimed in claim 1, wherein the image processing subsystem (70) of the computing device (30) is located on a cloud server and utilize a cloud server memory for offline content generation such as story book or video.

8. The system (10) as claimed in claim 1, further comprising a stand configured to hold the computing device (30) at an angle to the surface (20).

9. A method (150) comprising:
providing a medium for a first user input; (160)
monitoring and controlling the navigation based on a second user input; (170)
transferring the first user input to the computing device as a visual object; (180)
identifying a region of interest in the visual object; (190)
converting the region of interest into a plurality of vector objects; (200) and
mapping a predefined animation on the plurality of vector objects to enable creative playing. (210)

10. The method (100) as claimed in claim 1, wherein mapping the predefined animation on the plurality of vector objects comprises mapping the predefined animation on the plurality of vector objects to create a storyline from the user input.
